(19) United States
(12) Patent Application Publication
(10) Pub. No.: US 2014/0129292 A1
(43) Pub. Date: May 8, 2014

(54) FACILITATING SOCIAL INTERACTION USING PURCHASE OR INTEREST HISTORY

(71) Applicant: EBAY INC., San Jose, CA (US)

(72) Inventor: Jean-David Ruvini, Los Gatos, CA (US)

(73) Assignee: eBay Inc., San Jose, CA (US)

(21) Appl. No.: 13/670,958

(22) Filed: Nov. 7, 2012

(51) Int. Cl. G06Q 30/02

(52) U.S. Cl. 705/7.34; 705/7.29

(57) ABSTRACT

An apparatus and method for facilitating social connections are disclosed herein. A purchase or interest in a first item by a first user is tracked. A match between one or more second users and the first user is determined, each of the one or more second users having purchased or shown interest in the first item and located in a same geographical area as the first user. Providing a notification to a device associated with the first user, the notification configured to facilitate initiating contact with one or more of the matching second users.

### TECHNICAL FIELD

The present invention relates generally to data processing and more specifically, to facilitating social interaction using purchase history.

### BACKGROUND

Electronic commerce (e-commerce) or electronic marketplace systems are rich sources of purchase history data. Purchase history data, such as which items are purchased, the frequency of item purchases, type of items purchased, and the like, is tracked for each user interfacing with the e-commerce or marketplace system. A common use of such purchase history data is to recommend item(s) to a given user based on the purchase history data of a plurality of users. Another use of purchase history data is to tailor incentives, such as promotions or coupons, for particular users to make additional purchases at the e-commerce or marketplace system. While such recommendations or incentives serve to tempt users to make additional purchases, purchase history data may also be used for non-commercial purposes.

### BRIEF DESCRIPTION OF THE DRAWINGS

Some embodiments are illustrated by way of example and not limitations in the figures of the accompanying drawings, in which:

FIG. 1 illustrates a network diagram depicting an example system to facilitate social connection or interaction according to some embodiments.

FIG. 2 illustrates a block diagram showing components provided within the networked system included in the system of FIG. 1 according to some embodiments.

FIG. 3 illustrates an example block diagram showing localized buyer matching mechanism functionalities/operations implemented in modules and libraries/data structures/databases according to some embodiments.

FIGS. 4A-4B illustrate example flow diagrams for performing localized buyer matching to facilitate social connection and/or interaction implemented by the modules of FIG. 3 according to some embodiments.

FIG. 5 illustrates a diagrammatic representation of a machine in the example form of a computer system within which a set of instructions, for causing the machine to perform any one or more of the methodologies of FIGS. 4A-4B according to some embodiments.

The headings provided herein are for convenience only and do not necessarily affect the scope or meaning of the terms used.

### DETAILED DESCRIPTION

Described in detail herein is an apparatus and method for matching users based on their item purchase and/or item interest histories. A second user matches a first user based on their item purchase and/or interest histories and geo-proximity to each other. A notification identifying the matching second user is provided to the first user. In response, the first user can contact the second user via email, text, call, in-person, or other communication methods to initiate a social connection or interaction with the second user. The second user may be a person who is worthwhile getting to know because they share a common interest or has item information valuable to the first user. One or more second users can be matched to the first user for each time period. The first user and second user(s) are among the plurality of users that have interfaced with an electronic commerce or marketplace system. The system takes into account and respects the privacy concerns and preferences specified by each of the plurality of users. For example, if a given user specifies excluding certain purchases or item categories from being considered for matches, such exclusions will not be used to find matches for the given user nor for other users.

Various modifications to the example embodiments will be readily apparent to those skilled in the art, and the generic principles defined herein may be applied to other embodiments and applications without departing from the scope of the invention. Moreover, in the following description, numerous details are set forth for the purpose of explanation. However, one of ordinary skill in the art will realize that the invention may be practiced without the use of these specific details. In other instances, well-known structures and processes are not shown in block diagram form in order not to obscure the description of the invention with unnecessary detail. Thus, the present disclosure is not intended to be limited to the embodiments shown, but is to be accorded the widest scope consistent with the principles and features disclosed herein.

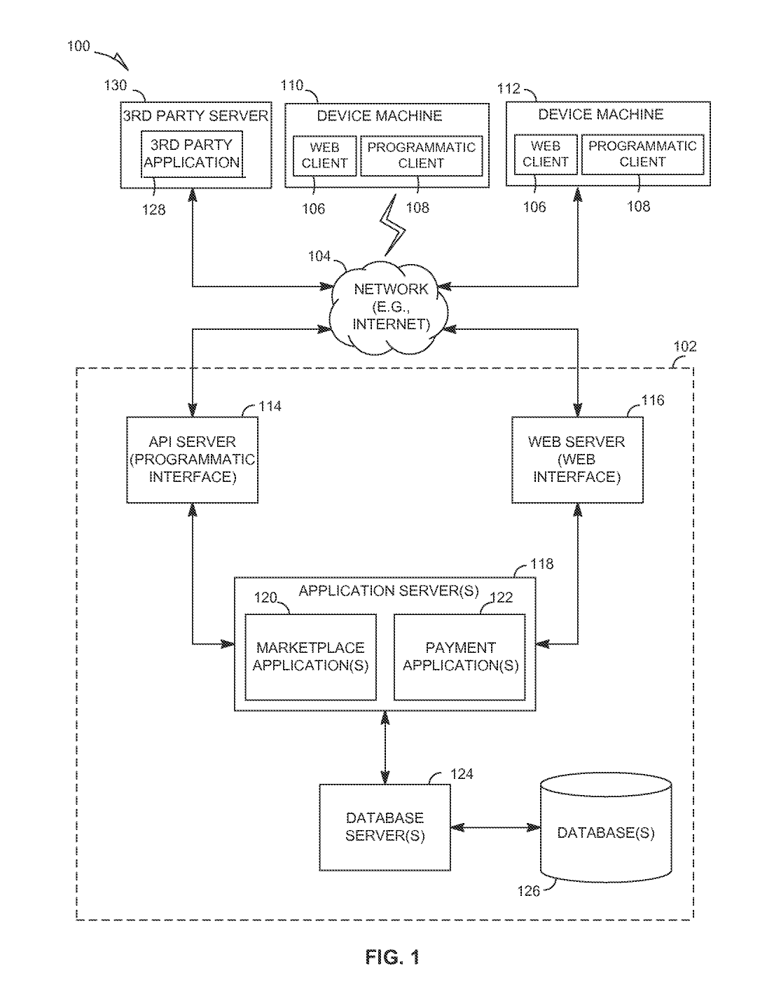

FIG. 1 illustrates a network diagram depicting an example system 100 to facilitate social connection or interaction according to some embodiments. A networked system 102 forms a network-based publication system that provides server-side functionality, via a network 104 (e.g., the Internet or Wide Area Network (WAN)), to one or more clients and devices. FIG. 1 further illustrates, for example, one or both of a web client 106 (e.g., a web browser) and a programmatic client 108 executing on device machines 110 and 112. In one embodiment, the publication system 100 comprises a marketplace system. In another embodiment, the publication system 100 comprises other types of systems such as, but not limited to, a social networking system, a matching system, a recommendation system, an electronic commerce (e-commerce) system, and the like.

Each of the device machines 110, 112 comprises a computing device that includes at least a display and communication capabilities with the network 104 to access the networked system 102. The device machines 110, 112 comprise, but are not limited to, remote devices, work stations, computers, general purpose computers, Internet appliances, hand-held devices, wireless devices, portable devices, wearable computers, cellular or mobile phones, portable digital assistants (PDAs), smart phones, tablets, ultrabooks, netbooks, laptops, desktops, multi-processor systems, microprocessor-based or programmable consumer electronics, game consoles, set-top boxes, network PCs, mini-computers, and the like. Each of the device machines 110, 112 may connect with the network 104 via a wired or wireless connection. For example, one or more portions of network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

Each of the device machines 110, 112 includes one or more applications (also referred to as “apps”) such as, but not limited to, a web browser, messaging application, electronic mail (email) application, an e-commerce site application, a marketplace application, a localized buyer matching mechanism, and the like. In some embodiments, if the localized buyer matching mechanism is included in a given one of the device machines 110, 112, then this mechanism is configured to locally provide the user interface and at least some of the functionalities with the mechanism configured to communicate with the networked system 102, on an as needed basis, for data and/or processing capabilities not locally available (such as detection of relevant purchase histories, generating matching notifications, etc.). Conversely if the localized buyer matching mechanism is not included in a given one of the device machines 110, 112, the given one of the device machines 110, 112 may use its web browser to access the mechanism hosted on the networked system 102. Although two device machines 110, 112 are shown in FIG. 1, more or less than two device machines can be included in the system 100.

An Application Program Interface (API) server 114 and a web server 116 are coupled to, and provide programmatic and web interfaces respectively to, one or more application servers 118. The application servers 118 host one or more marketplace applications 120 and payment applications 122. The application servers 118 are, in turn, shown to be coupled to one or more databases servers 124 that facilitate access to one or more databases 126.

The marketplace applications 120 may provide a number of e-commerce functions and services to users that access networked system 102. E-commerce functions/services may include a number of publisher functions and services (e.g., search, listing, content viewing, payment, etc.). For example, the marketplace applications 120 may provide a number of services and functions to users for listing goods and/or services or offers for goods and/or services for sale, searching for goods and services, facilitating transactions, and reviewing and providing feedback about transactions and associated users. Additionally, the marketplace applications 120 may track and store data and metadata relating to listings, transactions, and user interactions. In some embodiments, the marketplace applications 120 may publish or otherwise provide access to content items stored in application servers 118 or databases 126 accessible to the application servers 118 and/or the database servers 124. The payment applications 122 may likewise provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for products or items (e.g., goods or services) that are made available via the marketplace applications 120. While the marketplace and payment applications 120 and 122 are shown in FIG. 1 to both form part of the networked system 102, it will be appreciated that, in alternative embodiments, the payment applications 122 may form part of a payment service that is separate and distinct from the networked system 102. In other embodiments, the payment applications 122 may be omitted from the system 100. In some embodiments, at least a portion of the marketplace applications 120 may be provided on the device machines 110 and/or 112.

Further, while the system 100 shown in FIG. 1 employs a client-server architecture, embodiments of the present disclosure is not limited to such an architecture, and may equally well find application in, for example, a distributed or peer-to-peer architecture system. The various marketplace and payment applications 120 and 122 may also be implemented as standalone software programs, which do not necessarily have networking capabilities.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace, or payment functions that are supported by the relevant applications of the networked system 102.

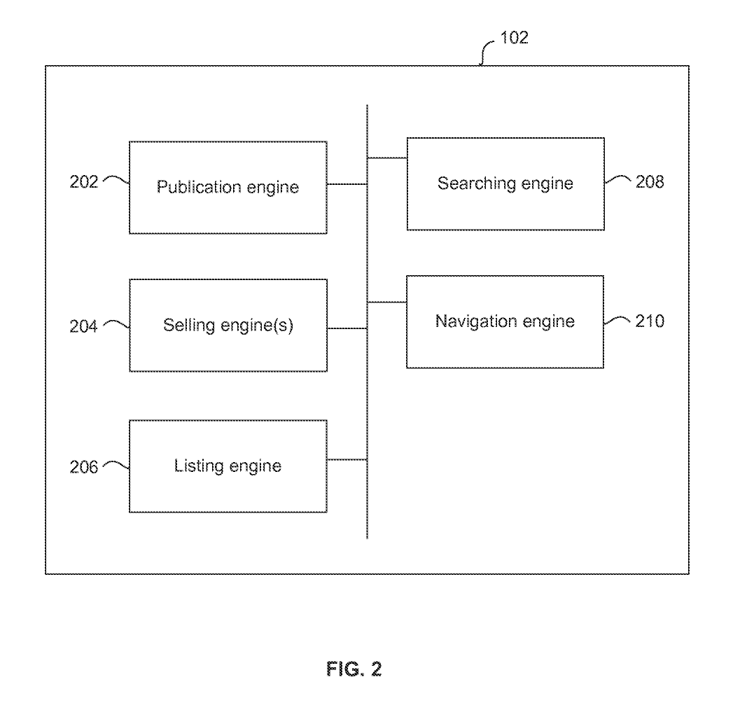

FIG. 2 illustrates a block diagram showing components provided within the networked system 102 according to some embodiments. The networked system 102 may be hosted on dedicated or shared server machines (not shown) that are communicatively coupled to enable communications between server machines. The components themselves are communicatively coupled (e.g., via appropriate interfaces) to each other and to various data sources, so as to allow information to be passed between the applications or so as to allow the applications to share and access common data. Furthermore, the components may access one or more databases 126 via the data servers 128.

The networked system 102 may provide a number of publishing, listing, and/or price-setting mechanisms whereby a seller may list (or publish information concerning) goods or services for sale or barter, a buyer can express interest in or indicate a desire to purchase or barter such goods or services, and a transaction may be completed pertaining to the goods or services. To this end, the networked system 102 may comprise at least one publication engine 202 and one or more selling engines 204. The publication engine 202 may publish information, such as item listings or product description pages, on the networked system 102. In some embodiments, the selling engines 204 may comprise one or more fixed-price engines that support fixed-price listing and price setting mechanisms and one or more auction engines that support auction-format listing and price setting mechanisms (e.g., English, Dutch, Chinese, Double, Reverse auctions, etc.). The various auction engines may also provide a number of features in support of these auction-format listings, such as a reserve price feature whereby a seller may specify a reserve price in connection with a listing and a proxy-bidding feature whereby a bidder may invoke automated proxy bidding. The selling engines 204 may further comprise one or more deal engines that support merchant-generated offers for products and services.

A listing engine 206 allows sellers to conveniently author listings of items or authors to author publications. In one embodiment, the listings pertain to goods or services that a user (e.g., a seller) wishes to transact via the networked system 102. In some embodiments, the listings may be an offer, deal, coupon, or discount for the good or service. Each good or service is associated with a particular category. The listing engine 206 may receive listing data such as title, description, and aspect name/value pairs. Furthermore, each listing for a good or service may be assigned an item identifier. In other embodiments, a user may create a listing that is an advertisement or other form of information publication. The listing information may then be stored to one or more storage devices coupled to the networked system 102 (e.g., databases 126). Listings also may comprise product description pages that display a product and information (e.g., product title, specifications, and reviews) associated with the product. In some embodiments, the product description page may include an aggregation of item listings that correspond to the product described on the product description page.

The listing engine 206 also may allow buyers to conveniently author listings or requests for items desired to be purchased. In some embodiments, the listings may pertain to goods or services that a user (e.g., a buyer) wishes to transact via the networked system 102. Each good or service is associated with a particular category. The listing engine 206 may receive as much or as little listing data, such as title, description, and aspect name/value pairs, that the buyer is aware of about the requested item. In some embodiments, the listing engine 206 may parse the buyer's submitted item information and may complete incomplete portions of the listing. For example, if the buyer provides a brief description of a requested item, the listing engine 206 may parse the description, extract key terms and use those terms to make a determination of the identity of the item. Using the determined item identity, the listing engine 206 may retrieve additional item details for inclusion in the buyer item request. In some embodiments, the listing engine 206 may assign an item identifier to each listing for a good or service.

In some embodiments, the listing engine 206 allows sellers to generate offers for discounts on products or services. The listing engine 206 may receive listing data, such as the product or service being offered, a price and/or discount for the product or service, a time period for which the offer is valid, and so forth. In some embodiments, the listing engine 206 permits sellers to generate offers from the sellers' mobile devices. The generated offers may be uploaded to the networked system 102 for storage and tracking.

Searching the networked system 102 is facilitated by a searching engine 208. For example, the searching engine 208 enables keyword queries of listings published via the networked system 102. In example embodiments, the searching engine 208 receives the keyword queries from a device of a user and conducts a review of the storage device storing the listing information. The review will enable compilation of a result set of listings that may be sorted and returned to the client device (e.g., device machine 110, 112) of the user. The searching engine 308 may record the query (e.g., keywords) and any subsequent user actions and behaviors (e.g., navigations).

The searching engine 208 also may perform a search based on the location of the user. A user may access the searching engine 208 via a mobile device and generate a search query. Using the search query and the user's location, the searching engine 208 may return relevant search results for products, services, offers, auctions, and so forth to the user. The searching engine 208 may identify relevant search results both in a list form and graphically on a map. Selection of a graphical indicator on the map may provide additional details regarding the selected search result. In some embodiments, the user may specify as part of the search query a radius or distance from the user's current location to limit search results.

The searching engine 208 also may perform a search based on an image. The image may be taken from a camera or imaging component of a client device or may be accessed from storage.

In a further example, a navigation engine 210 allows users to navigate through various categories, catalogs, or inventory data structures according to which listings may be classified within the networked system 102. For example, the navigation engine 210 allows a user to successively navigate down a category tree comprising a hierarchy of categories (e.g., the category tree structure) until a particular set of listing is reached. Various other navigation applications within the navigation engine 210 may be provided to supplement the searching and browsing applications. The navigation engine 210 may record the various user actions (e.g., clicks) performed by the user in order to navigate down the category tree.

Additional modules and engines associated with the networked system 102 are described below in further detail. It should be appreciated that modules or engines may embody various aspects of the details described below.

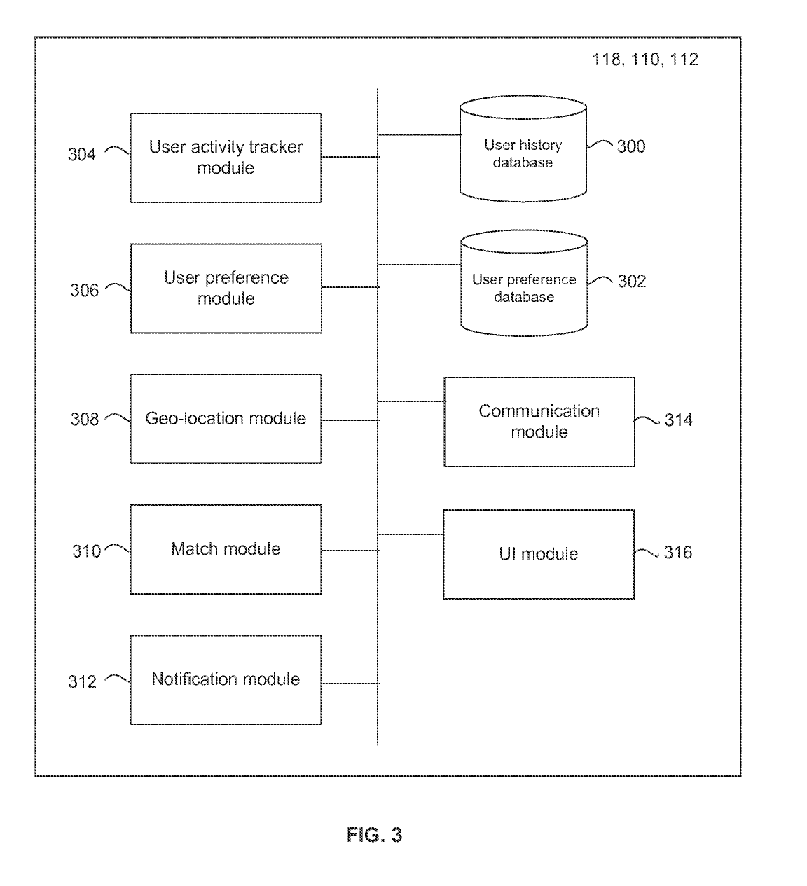

FIG. 3 illustrates an example block diagram showing localized buyer matching mechanism functionalities/operations implemented in modules and libraries/data structures/databases according to some embodiments. The modules comprise one or more software components, programs, applications, apps, or other units of code base or instructions configured to be executed by one or more processors included in the application servers 118, device machine 110, and/or device machine 112. The modules include a user activity tracker module 304, a user preference module 306, a geo-location module 308, a match module 310, a notification module 312, a communication module 314, and a user interface (UI) module 316. The modules 304-316 can communicate with each of a user history database 300 and a user preference database 302. Databases 300, 302 may be included in the database(s) 126. Although modules 304-316 are shown as distinct modules in FIG. 3, it should be understood that modules 304-316 may be implemented as fewer or more modules than illustrated. It should also be understood that any of modules 304-316 may communicate with one or more components included in the system 100, such as database servers 124, application servers 118, third party server 130, device machine 110, or device machine 112. Similarly, databases 300, 302 are shown as distinct databases in FIG. 3. However, it is understood that the content of databases 300, 302 may be stored in fewer or more databases than illustrated.

In some embodiments, one or more of modules 304-316 are downloaded from an e-commerce site (or electronic marketplace) appropriate for the type of computing device. For example, if the device machine 110 (or device machine 112) comprises an iOS-type device (e.g., iPhone, iPad), then the modules (which can be packaged as part of an app) can be downloaded from iTunes. Similarly, if the device machine 110 (or device machine 112) comprises an Android-type device, then the modules can be downloaded from the Android Marketplace or Google Play store. The device machine 110 and/or device machine 112 has communication capabilities with servers or databases at a remote location (e.g., databases 126, database servers 124, API server 114, web server 116) to access data and/or processing capabilities as described in detail below.

In other embodiments, one or more of modules 304-316 may be hosted on the application servers 118 and no download of the modules is required on the device machines 110, 112. Instead, the modules may be accessed by device machines 110, 112 using a web browser over the network 104. In still other embodiments, some of the modules may be included in the device machines 110, 112 while other of the modules may be included in the application servers 118; the device machines 110, 112 communicating with the application servers 118 to together provide the appropriate functionalities.

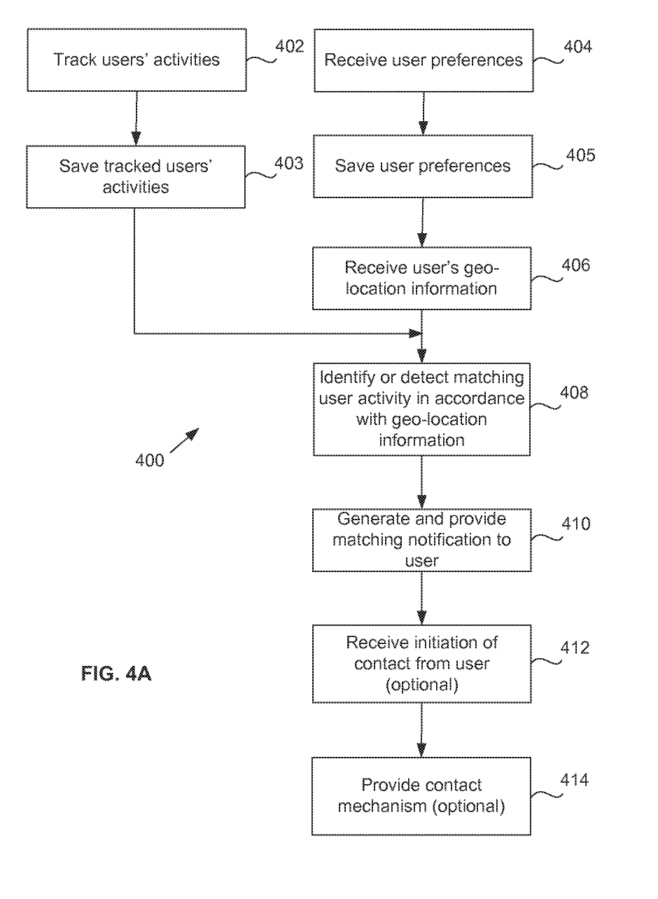

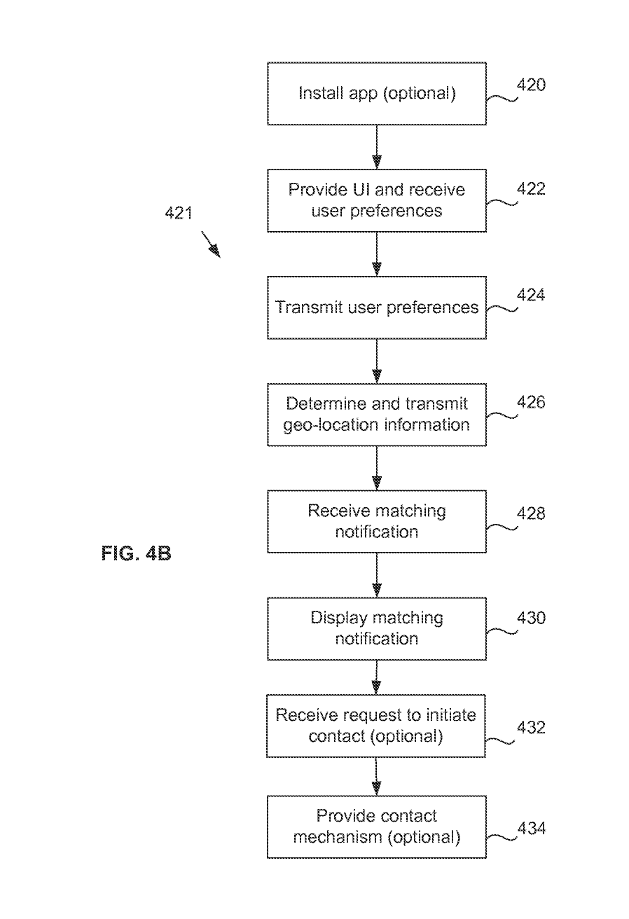

FIGS. 4A-4B illustrate example flow diagrams 400, 421 for performing localized buyer matching to facilitate social connection and/or interaction implemented by the modules of FIG. 3 according to some embodiments. The operations of the flow diagrams 400, 421 may be performed at the device machine 110, device machine 112, and/or a server included in the networked system 102 (e.g., API server 114, web server 116, or application servers 118). In some embodiments, the operations of flow diagram 400 are performed at a server included in the networked system 102 (e.g., API server 114, web server 116, or application servers 118), while operations of flow diagram 421 are performed at device machine 110 and/or 112. In other embodiments, the operations of flow diagrams 400, 421 can be performed at the device machine 110 and/or 112. In still other embodiments, the operations of flow diagram 421 and select portions of flow diagram 400 (e.g., blocks 408 or 410) can be performed at device machine 110 and/or 112, and the remaining portions of flow diagram 400 performed by a server included in the networked system 102 (e.g., API server 114, web server 116, or application servers 118). FIGS. 4A-4B are discussed below in conjunction with the modules and databases of FIG. 3.

At a block 402 of FIG. 4A, the user activity tracker module 304 is configured to track a plurality of users' activities at one or more e-commerce or electronic marketplace sites. The plurality of users can be all users, all identifiable users (e.g., users who have uniquely logged in), or a subset of the identifiable users interfacing with the one or more e-commerce or electronic marketplace sites. For each of such users, user activities that are tracked include, but are not limited to, purchases of goods or services (collectively referred to as “items”) and interest in items offered by the one or more e-commerce or electronic marketplace sites. Item purchases include online purchases and/or offline purchases (purchases at physical stores/vendors affiliated with or accessible by the one or more e-commerce or electronic marketplace sites). User interest in an item is ascertained by, but is not limited to, the item being added to a wish list or saved list, the item being in a shopping cart but for which purchase is incomplete, click through associated with the item, item searches, page view of information about the item, viewing time of a page containing information about the item, page view history, bidding on the item (even if the given user does not win the auction), asking a seller of the item a question about the item, viewing reviews about the item, bookmarking a page or portion of a page about the item, blogging about the item, liking or sharing information about the item on a social network, tweeting about the item, or other indication of interest in a given item by the given user.

The user activity tracker module 304 is configured to store the tracked user activities for each of the plurality of users in the user history database 300 (block 403). The stored user activities are also referred to as purchase history, user purchase history, user interest history, item interest history, user item interest history, user activity history, or other similar variants. Blocks 402-403 can occur continuously and/or simultaneously with one or more of blocks 404-412.

At a block 404, the networked system 102 receives user preference(s) provided by a user (e.g., a first user) at, for example, device machine 110 or 112. The received user preference(s) comprise the user's permission, authorization, making public, or indicating preferences of what he or she is willing to share of his or her user activity history with other users. In some embodiments, if the user opts out of sharing any or certain of his/her user activity history, then the user does not get the benefit of other users' activity histories. In other embodiments, even if the user opts out of sharing all or certain of hisiher user activity history, the user may receive matching notifications based on other users' activity histories. Example user preferences include, but are not limited to, setting a time period of user activity history that is sharable (e.g., use only the last 30 days of user activity history); excluding specific orders; excluding specific purchased or interested items; excluding certain types or categories of purchased or interested items (e.g., lingerie); excluding items intended to be gifts; excluding user activity on one or more sites; or the like.

Then at a block 405, the received user preference(s) are stored in the user preference database 302 by the user preference module 306. The user preference(s) are associated with a particular user identifier. The user identifier can be explicitly provided by the user (e.g., user login) or implicitly provided by the device machine 110 or 112 (e.g., device identification number, Internet Protocol (IP) address, phone number, etc.).

Next at a block 406, the geo-location module 308 receives (current) geo-location information about the user. It is assumed that the geo-location of the user and the device machine 110 or 112 are the same. The geo-location information can be provided automatically, continuously, periodically, and/or on an as-needed-basis by the device machine 110 or 112 to the networked system 102. For example, the device machine 110 or 112 can include a global positioning satellite (GPS) chip that provides GPS coordinates to the networked system 102. As another example, the device machine 110 or 112 can perform triangulation using cellular base stations to determine and provide geo-location information. In another example, the device machine 110 or 112 can request geo-location information from the user (e.g., request a zip code, city, address, county, etc.) and then provide such user input to the networked system 102.

The match module 310, at a block 408, is configured to identify or detect one or more users in the same vicinity as a particular user (referred to hereinafter as the first user) who has a matching user activity (e.g., purchase history, item interest history, shared interest history) to the first user. The match module 310 finds the one or more matching users based on the activity history of a plurality of users (in user history database 300), the first user's activity history (in user history database 300), the first user's geo-location (from block 406), and the geo-locations of the plurality of users. The one or more matching users are also referred to as second user(s), matching user(s), matching buyer(s), or matching purchaser(s). The geo-location of each of the plurality of users can be obtained from such users providing their geo-location information (as described above with respect to block 406) or from the shipping address of the item purchased. The match module 310 finds a match based on (1) a same geo-location for the first user and the second user, and (2) a purchase or interest by both the first and second users in the same item or class of item.

The geo-locations respectively corresponding to the first and second users are deemed to be the same or a match if both geo-locations are within a pre-defined range or parameter of each other. Examples of pre-defined ranges or parameters include, but are limited to, within 50 miles, within the same city, within the same county, within the same metropolitan area, within the same neighborhood, within the same zip code, within the same school district, or any other locality that may be deemed to be within the same vicinity of each other. In some embodiments, the match module 310 can start with a smaller pre-defined range and if no matching second user is found, the pre-defined range may be expanded to a larger pre-defined range and the matching process can be repeated. Alternatively, if too many matching second users are found (e.g., above a pre-defined number), then a smaller pre-defined range may be used to identify a smaller number of matching second users.

If any pair of first and second users satisfies one or more of the following purchase or interest match criteria, then such second user is deemed to be a matching second user (provided the geo-location requirement above is also met) for the first user:
Both the first and second user buy item X.
First user buys item X and second user shows interest in item X.
First user shows interest in item X and second user buys item X.
First user buys and/or shows interest in items X, Y, and Z. Second user buys and/or shows interest in items A, B, and C. Items X, Y, Z, A, B, and C comprise a particular class, family, or type of items relating to a particular activity, hobby, or interest. Infer that both first and second users have a shared interest in the particular activity. Purchasing and/or showing interest in several different items related to a particular activity indicates an interest in that activity. For example, the first user purchases running shoes X, running shorts Y, and dress shoes S. A second user purchases an app for tracking runs A and showed interest in running top B. Items X, Y, A, and B relate to running. The match module 310 determines that the first and second user have a shared interest in running.

One or more additional match criteria can also be applied by the match module 310 to identify matching second user(s) for the first user. For instance, a pre-defined time constraint may be applied so that matching items are those purchased and/or interested in by the first and second user within a month, two months, six months, a year, or other pre-defined time period of each other. As another example, for a user to qualify as a matching second user, the user may be required to have purchased at least N number of items from a particular category (e.g., purchase at least three items from the digital camera/photography category to show some expertise in digital camera/photography), have a certain feedback score (the user's reputation within the marketplace, such as based on a number of positive ratings or endorsements of the user from other users of the marketplace), has written review(s), purchased a refurbished or used item, or other system or first user constraints. As still another example, a user may qualify as a matching second user upon being a repetitive match at the same geo-location over a certain time period.

Based on the matching second user(s) identified in block 408, the notification module 312 is configured to generate and provide a matching notification to the first user (block 410). The matching notification is provided to the first user's device (e.g., device machine 110 or 112) for display to the first user. The matching notification comprises notifying the first user of the matching second users, the item(s) in common with each of the respective second users, and option(s) for contacting the respective second users. Examples of matching notifications include, but are not limited to:
Anne B. bought the same item X as you. Would you like to meet Anne B. to share common interests? Contact Anne B.: YES NO
Max M. bought an item X that you are interested in. Would you like to contact Max M. to see, learn about, or discuss the item? Contact Max M.: YES NO
Tom shares your interest in running. Would you like to meet Tom?
   In some embodiments, the matching notification can further include cumulative information about matching second users. For example, the matching notification can include information about a second user being a repeat match: “Max M. bought 5 items that you have also purchased and/or are interest in. You and Max M. share a common interest in running. Would you like to meet Max M. to talk about running?”

In some embodiments, block 408 may be performed more frequently than block 410. In other embodiments, block 410 may performed each time block 408 has been performed. Blocks 408 and/or 410 may be performed periodically, continuously, in response to a trigger, or as processing capacity allows.

In response to the first user receiving the matching notification, the first user may wish to contact one or more of the identified second users to discuss the common item, to make friends with others who seem to share a common interest, and the like. The matching notification provided to the first user can include user interface (UI) elements for the first user to indicate contact initiation with a second user. Such indication to initiate contact is received by the communication module 314 at a block 412.

At a block 414, the communication module 314 is configured to facilitate the first user in contacting a second user (e.g., providing a contact or communication mechanism). Numerous (initial) contact mechanisms are contemplated including, but not limited to, requesting authentication of the first user (e.g., requesting a valid username and password) prior to providing the second user's contact information (e.g., email address, phone number, etc.) to the first user, serving as a middleman so that the first user can compose and send a message to the second user without the second user's contact information being revealed to the first user; requesting the second user to agree to being contacted by the first user prior to providing the second user's contact information to the first user; and the like. The communication module 314 takes into account privacy and security concerns so that the first user's initial contact is legitimate and not likely to be considered as spam by the second user.

The first user can contact the second user via electronic mail (email), text, phone call, in-person, or other communication methods. The first user can compose a message specifying how he or she would like to meet, talk, or otherwise interact with the second user. For example, the first user may propose meeting in a public place such as a coffee shop to discuss the best running accessories. In some embodiments, the localized buyer matching app can include communication features, such as integrated email or texting capabilities, so that the first user can contact the second user without leaving the app. In other embodiments, the localized buyer matching app can launch another app, such as an email or texting app included in the first user's device, for the first user to complete the contacting process. In still other embodiments, the second user's contact information is provided by the localized buyer matching app and the first user is then free to use any preferred contacting method or app.

Turning to FIG. 4B, operations performed at the first user's device (e.g., device machine 110 or 112) are shown in an example embodiment. At a block 420, the localized buyer matching app (or widget, modules, etc.) is installed on the first user's device if the app is being used for the first time. Alternatively, block 420 may be optional if the functionalities of the app are provided by the networked system 102 via a web browser included in the first user's device.

Next at a block 422, the UI module 316 is configured to provide one or more UI elements and/or screens associated with user preference settings and to receive user preferences from the first user in coordination with the user preference module 306. Additional details regarding user preferences are discussed above with respect to blocks 404 and 405 (FIG. 4A). The user preferences specified by the first user are transmitted from the first user's device to the networked system 102 (block 424). The transmitted user preferences are received at the block 404 (FIG. 4A).

At a block 426, the geo-location module 308 is configured to determine and transmit geo-location information corresponding to the first user's device. The geo-location information is received at the block 406 (FIG. 4A). As discussed above with respect to block 406, the geo-location information (also referred to as location information, geographic location information, and the like) can be determined, for example, using GPS, triangulation, provided by the wireless (e.g., cellular) carrier, or by the first user's input of his or her current location. The degree of accuracy of the geo-location information (e.g., accurate to within one foot, one block, one mile, etc.) may be set by the first user's device and/or based on the degree of accuracy to be used in identifying matching second users.

If or when matching second user(s) are identified and a matching notification corresponding to the matching second user(s) generated, then such matching notification is received at a block 428. Additional details regarding the matching notification are discussed above with respect to block 410 (FIG. 4A). The received matching notification is displayed on a screen of the first user's device at a block 430 (in coordination with the UI module 316). The matching notification can be push notifications that are automatically displayed (either in part or in full) when it is received at the first user's device. For example, an icon, banner, bar, a new window, or other display indication are contemplated. As another example, the initial display indication may contain minimal information and then in response to the first user's interest in the indication, more information may be displayed. Alternatively the matching notification may be displayed when the localized buyer matching app is launched.

The matching notification and/or other UI elements displayed on the first user's device are configured to solicit or receive the first user's response to the matching notification. The communication module 314 is configured to receive a request by the first user to contact one or more of the particular second users identified in the matching notification (block 432). The communication module 314 can also facilitate contacting the second user(s) selected by the first user (block 434). Additional details regarding contacting the identified second user(s) are discussed above for blocks 412-414 of FIG. 4A.

In this manner, the localized buyer matching mechanism facilitates social interaction or connection between users who are identified as having one or more item purchases and/or item interest in common. Item purchases and interest history of a plurality of users interfacing with an e-commerce or electronic marketplace site are used to search for matches between pairs of users located within the same area. A second user matches a first user based on their item purchase and/or interest histories and geo-proximity to each other. A matching notification providing information about the matching second user is provided to the first user. The first user may decide to contact such second user based on the shared common interest in the item, activity using the item, or other indication of commonality.

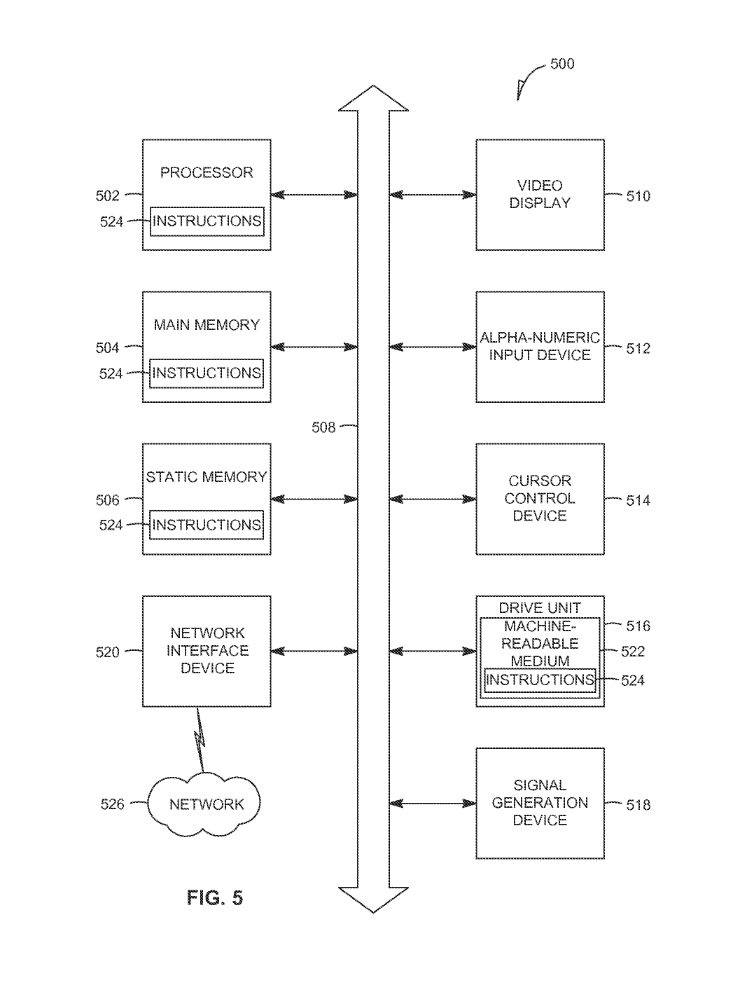

FIG. 5 shows a diagrammatic representation of a machine in the example form of a computer system 500 within which a set of instructions, for causing the machine to perform any one or more of the methodologies discussed herein, may be executed. The computer system 500 comprises, for example, any of the device machine 110, device machine 112, applications servers 118, API server 114, web server 116, database servers 124, or third party server 130. In alternative embodiments, the machine operates as a standalone device or may be connected (e.g., networked) to other machines. In a networked deployment, the machine may operate in the capacity of a server or a device machine in server-client network environment, or as a peer machine in a peer-to-peer (or distributed) network environment. The machine may be a server computer, a client computer, a personal computer (PC), a tablet, a set-top box (STB), a Personal Digital Assistant (PDA), a smart phone, a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 502 (e.g., a central processing unit (CPU), a graphics processing unit (GPU), or both), a main memory 504 and a static memory 506, which communicate with each other via a bus 508. The computer system 500 may further include a video display unit 510 (e.g., liquid crystal display (LCD), organic light emitting diode (OLED), touch screen, or a cathode ray tube (CRT)). The computer system 500 also includes an alphanumeric input device 512 (e.g., a physical or virtual keyboard), a cursor control device 514 (e.g., a mouse, a touch screen, a touchpad, a trackball, a trackpad), a disk drive unit 516, a signal generation device 518 (e.g., a speaker) and a network interface device 520.

The disk drive unit 616 includes a machine-readable medium 522 on which is stored one or more sets of instructions 524 (e.g., software) embodying any one or more of the methodologies or functions described herein. The instructions 524 may also reside, completely or at least partially, within the main memory 504 and/or within the processor 502 during execution thereof by the computer system 500, the main memory 504 and the processor 502 also constituting machine-readable media.

The instructions 524 may further be transmitted or received over a network 526 via the network interface device 520.

While the machine-readable medium 522 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

It will be appreciated that, for clarity purposes, the above description describes some embodiments with reference to different functional units or processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Certain embodiments described herein may be implemented as logic or a number of modules, engines, components, or mechanisms. A module, engine, logic, component, or mechanism (collectively referred to as a “module”) may be a tangible unit capable of performing certain operations and configured or arranged in a certain manner. In certain example embodiments, one or more computer systems (e.g., a standalone, client, or server computer system) or one or more components of a computer system (e.g., a processor or a group of processors) may be configured by software (e.g., an application or application portion) or firmware (note that software and firmware can generally be used interchangeably herein as is known by a skilled artisan) as a module that operates to perform certain operations described herein.

In various embodiments, a module may be implemented mechanically or electronically. For example, a module may comprise dedicated circuitry or logic that is permanently configured (e.g., within a special-purpose processor, application specific integrated circuit (ASIC), or array) to perform certain operations. A module may also comprise programmable logic or circuitry (e.g., as encompassed within a general-purpose processor or other programmable processor) that is temporarily configured by software or firmware to perform certain operations. It will be appreciated that a decision to implement a module mechanically, in dedicated and permanently configured circuitry, or in temporarily configured circuitry (e.g., configured by software) may be driven by, for example, cost, time, energy-usage, and package size considerations.

Accordingly, the term “module” should be understood to encompass a tangible entity, be that an entity that is physically constructed, permanently configured (e.g., hardwired), non-transitory, or temporarily configured (e.g., programmed) to operate in a certain manner or to perform certain operations described herein. Considering embodiments in which modules or components are temporarily configured (e.g., programmed), each of the modules or components need not be configured or instantiated at any one instance in time. For example, where the modules or components comprise a general-purpose processor configured using software, the general-purpose processor may be configured as respective different modules at different times. Software may accordingly configure the processor to constitute a particular module at one instance of time and to constitute a different module at a different instance of time.

Modules can provide information to, and receive information from, other modules. Accordingly, the described modules may be regarded as being communicatively coupled. Where multiples of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices and can operate on a resource (e.g., a collection of information).

Although the present invention has been described in connection with some embodiments, it is not intended to be limited to the specific form set forth herein. One skilled in the art would recognize that various features of the described embodiments may be combined in accordance with the invention. Moreover, it will be appreciated that various modifications and alterations may be made by those skilled in the art without departing from the scope of the invention.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method for facilitating social connections, the method comprising:
tracking a purchase or interest in a first item by a first user;
matching, by a processor, one or more second users to the first user, each of the one or more second users having purchased or shown interest in the first item and located in a same geographical area as the first user; and
providing a notification to a device associated with the first user, the notification configured to facilitate initiating contact with one or more of the matching second users.

2. The method of claim 1, further comprising receiving geo-location information corresponding to the device.

3. The method of claim 1, further comprising receiving one or more user preferences corresponding to the first user, the user preferences comprising permission to use or exclude at least certain of the first user's purchase and interest history at one or more of electronic commerce or marketplace sites in the matching of the one or more second users to the first user.

4. The method of claim 3, wherein the user preferences comprise at least one of permission to use a certain time period of the first user's purchase and interest history, exclusion of certain item orders, exclusion of certain purchased or interested items, exclusion of gifts, exclusion of certain categories of items, or exclusion of activity on certain of the one or more electronic commerce or marketplace sites.

5. The method of claim 1, wherein the tracking of the interest in the first item includes tracking, on one or more electronic commerce or marketplace sites, the first item added to a wish list, the first item added to a saved list, the first added to a shopping cart, a click through corresponding to the first item, a search for the first item, a page view of information about the first item, a viewing time of information about the first item, a bid placed on the first item in an auction, asking a seller of the first item a question about the first item, viewing reviews about the first item, bookmarking a page or portion of the page about the first item, blogging about the first item, liking or sharing information about the first item on a social network, or tweeting about the first item.

6. The method of claim 1, wherein the tracking of the purchase of the first item includes tracking the first item purchased at one or more electronic commerce or marketplace sites, or the first item purchased offline with a vendor affiliated with the one or more electronic commerce or marketplace sites.

7. The method of claim 1, further comprising providing a communication mechanism in response to a request to initiate contact with one of the matching second users, the communication mechanism including at least one of an electronic mail, a text message, a phone call, or a messaging capability integrated with an electronic commerce or marketplace site.

8. The method of claim 1, the matching of the one or more second users comprises at least one of the first user and the second user purchasing the first item, the first user purchasing the first item and the second user showing interest in the first item, the first user showing interest in the first item and the second user purchasing the first item, or determining a shared interest for the first and second users based on a second item purchased or of interest by the second user, the first and second items belonging to a same category corresponding to the shared interest.

9. A non-transitory computer readable medium including instructions, when executed by a processor, causes the processor to perform operations comprising:
tracking a purchase or interest in a first item by a first user;
matching one or more second users to the first user, each of the one or more second users having purchased or shown interest in the first item and located in a same geographical area as the first user; and
providing a notification to a device associated with the first user, the notification configured to facilitate initiating contact with one or more of the matching second users.

10. The non-transitory computer readable medium of claim 9, further comprising receiving geo-location information corresponding to the device.

11. The non-transitory computer readable medium of claim 9, further comprising receiving one or more user preferences corresponding to the first user, the user preferences comprising permission to use or exclude at least certain of the first user's purchase and interest history at one or more of electronic commerce or marketplace sites in the matching of the one or more second users to the first user.

12. The non-transitory computer readable medium of claim 11, wherein the user preferences comprise at least one of permission to use a certain time period of the first user's purchase and interest history, exclusion of certain item orders, exclusion of certain purchased or interested items, exclusion of gifts, exclusion of certain categories of items, or exclusion of activity on certain of the one or more electronic commerce or marketplace sites.

13. The non-transitory computer readable medium of claim 9, wherein the tracking of the interest in the first item includes tracking, on one or more electronic commerce or marketplace sites, the first item added to a wish list, the first item added to a saved list, the first added to a shopping cart, a click through corresponding to the first item, a search for the first item, a page view of information about the first item, a viewing time of information about the first item, a bid placed on the first item in an auction, asking a seller of the first item a question about the first item, viewing reviews about the first item, bookmarking a page or portion of the page about the first item, blogging about the first item, liking or sharing information about the first item on a social network, or tweeting about the first item.

14. The non-transitory computer readable medium of claim 9, wherein the tracking of the purchase of the first item includes tracking the first item purchased at one or more electronic commerce or marketplace sites, or the first item purchased offline with a vendor affiliated with the one or more electronic commerce or marketplace sites.

15. The non-transitory computer readable medium of claim 9, further comprising providing a communication mechanism in response to a request to initiate contact with one of the matching second users.

16. The non-transitory computer readable medium of claim 15, wherein the communication mechanism includes at least one of an electronic mail, a text message, a phone call, or a messaging capability integrated with an electronic commerce or marketplace site.

17. A device, comprising:
at least one memory;
at least one processor in communication with the memory; and
one or more modules comprising instructions stored in the memory and executed by the processor to perform operations comprising:
in response to a first item purchased or being of interest to a first user, receiving a matching notification identifying one or more second users, each of the one or more second users having purchased or shown interest in the first item and located in a same geographical area as the first user; and
displaying, at a screen in communication with the processor, the matching notification.

18. The device of claim 17, wherein the matching notification is received in accordance with user preferences corresponding to the first user, the user preferences specifying sharing of the first item purchase or interest activity.

19. The device of claim 17, wherein the screen receives an indication from the first user to contact at least one of the second users.

20. The device of claim 19, wherein the processor initiates an electronic mail, a text message, a phone call, or a messaging function integrated with an electronic commerce or marketplace site to contact the at least one of the second users.
